(19) United States
(12) Patent Application Publication
(10) Pub. No.: US 2006/0153556 A1
(43) Pub. Date: Jul. 13, 2006

(54) Focal length adjustment apparatus with improved vibration and impact-resistance properties

(75) Inventors: Cheong Hee Lee, Yongin (KR); Ho Seop Jeong, Sungnam (KR); Jae Ho Baik, Busan (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/299,754

(22) Filed: Dec. 13, 2005

(30) Foreign Application Priority Data
Jan. 13, 2005 (KR) 10-2005-3269

(51) Int. Cl. G03B 13/34

(52) U.S. Cl. 396/133

(57) ABSTRACT

Disclosed herein is a focal length adjustment apparatus in which a magnetic fluid that serves as attenuation means is injected between a magnet and a coil to achieve an improvement in a magnetic flux density and damping effect. The apparatus comprises a moving unit including a lens barrel that contains at least one lens therein, and a coil arranged on an outer circumference of the lens barrel, a fixed unit including a yoke formed with an opening for receiving the lens barrel, a case into which the yoke is inserted and mounted, and a magnet affixed to the yoke to be arranged adjacent to the coil, a supporting member used to elastically support the moving unit relative to the case, and attenuation means interposed between the coil and the magnet to attenuate vibration of the moving unit.

### RELATED APPLICATIONS

The present application is based on, and claims priority from, Korean Application Number 2005-003269, filed Jan. 13, 2005, the disclosure of which is incorporated by reference herein in its entirety.

### BACKGROUND OF THE INVENTION

1. Field of the Invention

The present invention relates to a focal length adjustment apparatus using a voice coil motor (VCM), and more particularly, to a focal length adjustment apparatus in which a magnetic fluid that serves as attenuation means is injected between a magnet and a coil to achieve an improvement in a magnetic flux density and damping effect, whereby the strength of an electromagnetic force produced between the magnet and the coil can be enhanced and an impact-resistance property, a reliability in the adjustment of a focal length, and responsiveness can be improved.

2. Description of the Related Art

In general, a camera includes a plurality of lenses, and is designed to adjust an optical focal length via a movement of each of the lenses. Recently, with the appearance of a built-in camera of a type used in a cellular phone, photographing moving images as well as fixed images by means of the cellular phone is possible. The present tendency is to gradually improve the capacity of a camera to achieve high-resolution and high-definition pictures and moving images.

To satisfy the above requirement, it is necessary for a camera to have an automatic focal length adjustment function or optical zoom function. In particular, the automatic focal length adjustment function entails automatically adjusting the focus of a lens on an imaging sensor basis. It can be said that the automatic focal length adjustment function is the most fundamental function to obtain vivid images.

An example of a drive source to carry out the above function includes a small-scale electric motor, which is mainly used to generate a rotational force. In addition, certain drive means using piezoelectric elements or other various drive devices are also applicable.

Of various conventional drive sources, a representative one is a linear motor, which is referred to as a voice coil motor (VCM). The VCM is designed to generate a drive force by use of a speaker's vibration principle, and is generally classified into a mobile coil type VCM and a mobile magnet type VCM. In the mobile coil type VCM, a mobile coil carries out a reciprocating motion relative to a fixed magnet, whereas, in the mobile magnet type VCM, a mobile magnet carries out a reciprocating motion relative to a fixed coil.

As stated above, the VCM is able to perform a linear motion, thereby having no necessity of converting a rotating motion into a linear motion differently from a conventional electric motor. For this reason, the VCM is in the spotlight as a drive source for carrying out a linear motion within a narrow space, and is advantageous for use as a lens drive device of a small-scale camera.

Considering a conventional focal length adjustment apparatus using such a VCM, it is configured such that a lens barrel, which contains at least one lens therein, is linearly movable upon receiving an electromagnetic force generated based on Fleming's left-hand rule. Hereinafter, the configuration of the conventional focal length adjustment apparatus will be explained.

FIGS. 1A and 1B illustrate an example of a conventional focal length adjustment apparatus. As shown in FIGS. 1A and 1B, a pair of magnets 104 is fixedly arranged within a housing 101, and a holder 110 is located between the pair of magnets 104. The holder 110 is provided at opposite outer surfaces thereof with a pair of coils 106, respectively, so that the coils 106 are arranged adjacent to the magnets 104, respectively.

The holder 110 is centrally formed with a bore, so that a lens barrel 102 is assembled into the bore. The lens barrel 102 contains at least one lens therein, so that a focal length of the lens varies in accordance with movement of the holder 110.

The housing 101 and the holder 110 are connected at their upper ends to each other by use of a pair of plate springs 108, so that the holder 110 is supported relative to the housing 101. In such a connected state, if electric current is applied to the coils 106, the holder 10 is able to perform a linear motion upon receiving an electromagnetic force produced between the coils 106 and the magnets 104.

Simultaneously with the linear motion of the holder 110 as stated above, the lens received in the lens barrel 102 is moved, so that light reflected from an object that is being photographed is accurately concentrated on an imaging sensor (not shown). In this way, the conventional apparatus realizes a focal length adjustment function.

However, the conventional focal length adjustment apparatus configured as stated above has the following problems.

Firstly, although the holder 110 is supported by use of the plate springs 108, the holder 110 has no damping structure for the attenuation of vibration except for the plate springs 108. This makes the conventional focal length adjustment apparatus vulnerable to vibration in the case of unintentional falling or when an external shock is applied thereto.

The vulnerability in vibration disadvantageously increases a peak value in vibration at a resonance point, causing collisions between the holder 110 and other constituent elements. This degrades the durability of the conventional focal length adjustment apparatus and also, excessively increases a response time for focal length adjustment (i.e. a time required to stop the movement of the lens.

Further, the above-described insufficient damping makes it difficult to control an accurate position of the holder 110, and to accurately adjust the focus of the lens received in the lens barrel 102, resulting in many problems to obtain vivid photographs or images.

Furthermore, when it is desired to mount a large number of lenses in the lens barrel 102, the holder 101 that is coupled with the lens barrel 102 is inevitably subjected to an increased load, requiring a great force for easy transfer thereof. To achieve the great transfer_force, it is necessary to increase the amount of electric current to be applied to the coils 106 or to raise a magnetic flux density that is produced by the magnets 104.

Increasing the amount of electric current to be applied to the coils 106, however, results in an increase in the consumption of electricity. Also, raising the magnetic flux density requires to enhance the magnetism of the magnets 104, but the magnetism is a physical property value, and is difficult to vary.

### SUMMARY OF THE INVENTION

Therefore, the present invention has been made in view of the above problems, and it is an object of the present invention to provide a focal length adjustment apparatus in which a magnetic fluid is injected between a magnet and a coil to achieve an improvement in a magnetic flux density and damping effect, whereby the strength of an electromagnetic force produced between the magnet and the coil can be enhanced and an impact-resistance property, a reliability in the adjustment of a focal length, and responsiveness can be improved.

In accordance with an aspect of the present invention, the above and other objects can be accomplished by the provision of a focal length adjustment apparatus with improved vibration and impact-resistance properties, comprising: a moving unit including a lens barrel that contains at least one lens therein, and a coil arranged on an outer circumference of the lens barrel; a fixed unit including a yoke formed with an opening for receiving the lens barrel, a case into which the yoke is inserted and mounted, and a magnet affixed to the yoke to be arranged adjacent to the coil; a supporting member used to elastically support the moving unit relative to the case; and attenuation means interposed between the coil and the magnet to attenuate vibration of the moving unit.

Preferably, the supporting member may be a plate spring fixed to upper ends of both the lens barrel and the case to elastically support the lens barrel relative to the case.

Preferably, a cover may be coupled to the upper end of the case so that a viscous fluid is filled between the upper end of the case and the cover to surround the supporting member.

In this case, the attenuation means may be a viscous fluid, more preferably, may be a magnetic fluid having a viscosity. Also, an imaging sensor may be mounted in a lower region of the case so that a distance between the imaging sensor and the lens is adjustable.

In accordance with another aspect of the present invention, the above and other objects can be accomplished by the provision of a focal length adjustment apparatus with improved vibration and impact-resistance properties, comprising: a moving unit including a lens barrel that contains at least one lens therein and is formed with a pair of guide slots therethrough, and a coil arranged on an outer circumference of the lens barrel; a fixed unit including a yoke that is provided with an opening for receiving the lens barrel and a pair of guide protrusions to be inserted into the guide slots, respectively, a case into which the yoke is inserted and mounted, and a magnet affixed to the yoke to be arranged adjacent to the coil; a supporting member used to elastically support the moving unit relative to the case; and a viscous fluid interposed between the coil and the magnet to attenuate vibration of the moving unit, whereby the moving unit is linearly moved relative to the fixed unit upon receiving an electromagnetic force produced between the coil and the magnet, to adjust a focal length of the lens.

Preferably, the supporting member may be a plate spring fixed to upper ends of both the lens barrel and the case to elastically support the lens barrel relative to the case.

Preferably, a cover may be coupled to the upper end of the case so that a viscous fluid is filled between the upper end of the case and the cover to surround the supporting member.

In this case, the attenuation means may be a magnetic fluid having a viscosity, and an imaging sensor may be mounted in a lower region of the case so that a distance between the imaging sensor and the lens is adjustable.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B illustrate a conventional focal length adjustment apparatus, FIG. 1A being an exploded perspective view, and FIG. 1B being a perspective sectional view of the assembled focal length adjustment apparatus;

FIG. 2 is an exploded perspective view illustrating a focal length adjustment apparatus according to an embodiment of the present invention;

FIG. 3 is a perspective view illustrating an assembled state of a moving unit and a fixed unit of FIG. 2;

FIG. 4 is a perspective view illustrating an assembled state of a supporting member and a case of FIG. 2;

FIG. 5 is an exploded perspective view illustrating a case and a supporting member according to another embodiment of the present invention; and

FIGS. 6A and 6B illustrate a focal length adjustment apparatus having the case and the supporting member of FIG. 5, FIG. 6A being a general perspective view, and FIG. 6B being a perspective sectional view taken along the line A-A of FIG. 6A.

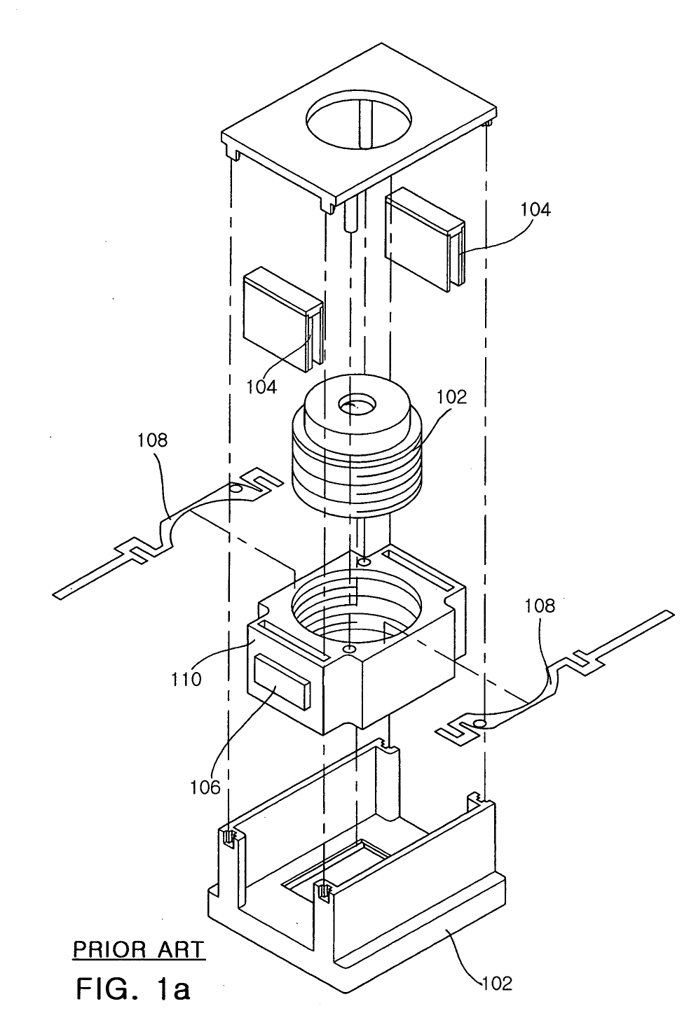

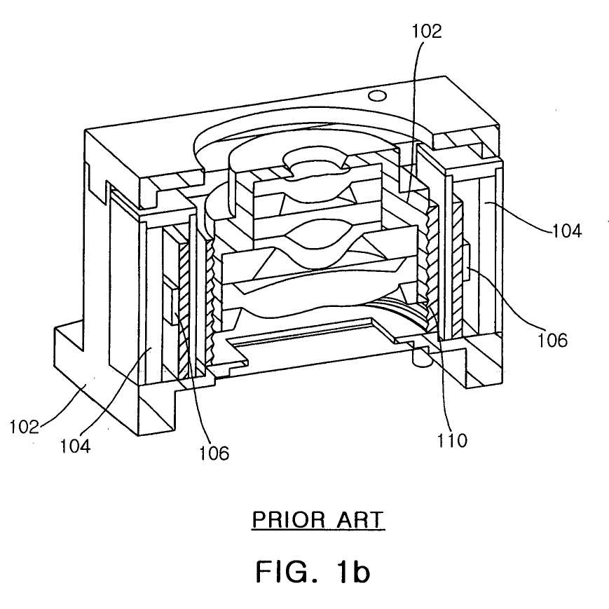

### DESCRIPTION OF THE PREFERRED EMBODIMENTS

Now, preferred embodiments of the present invention will be explained in more detail with reference to the accompanying drawings.

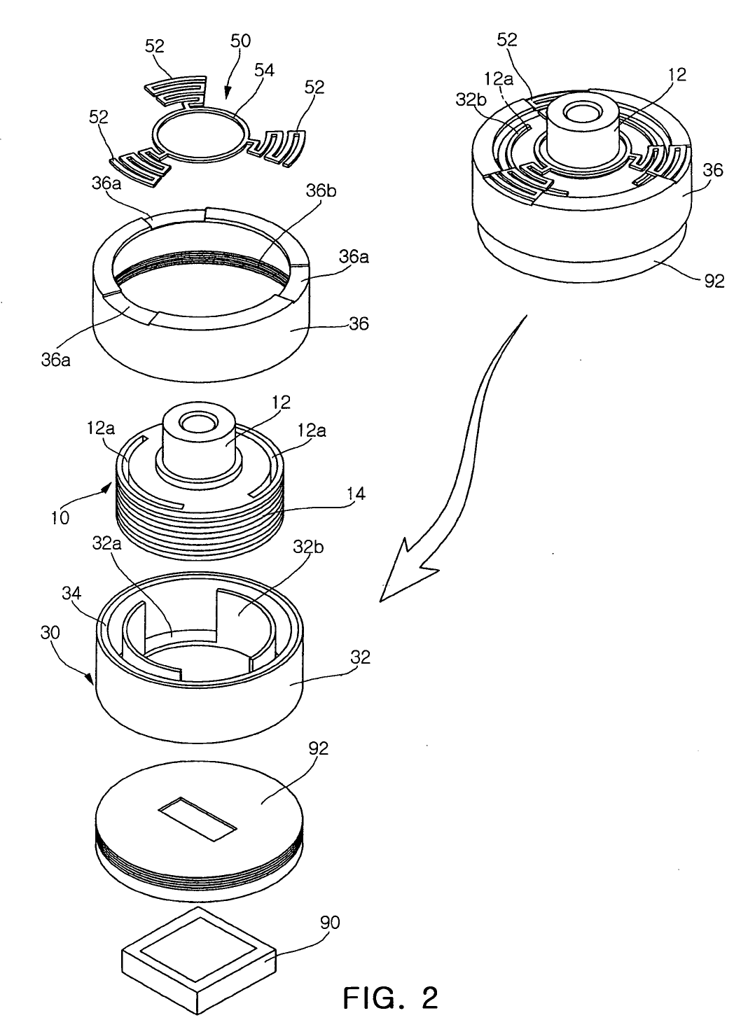

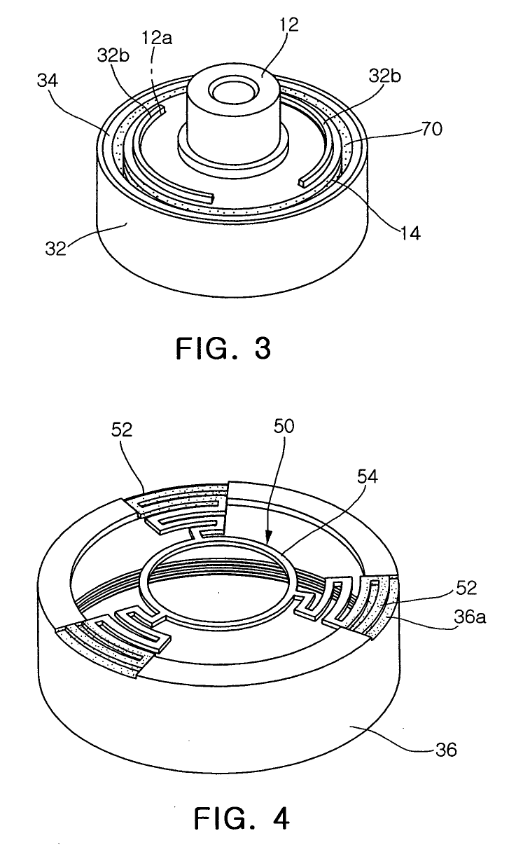

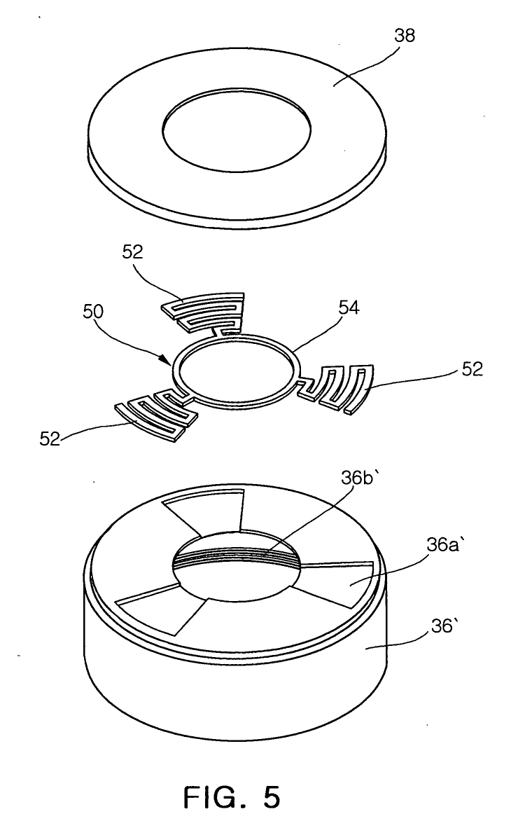

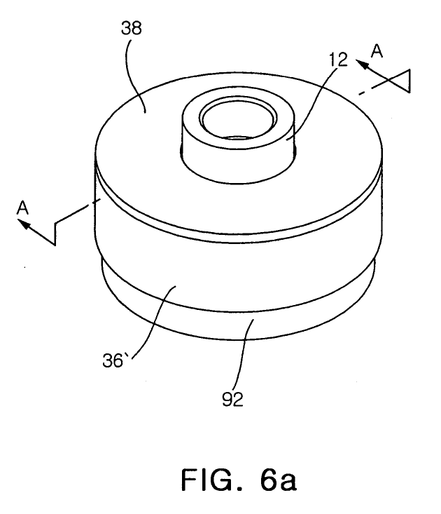

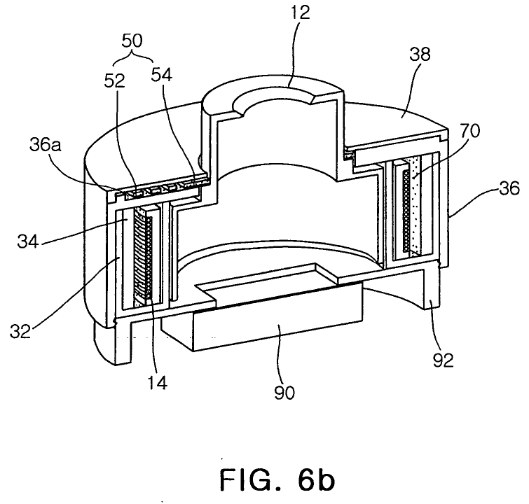

FIG. 2 is an exploded perspective view illustrating a focal length adjustment apparatus according to an embodiment of the present invention. FIG. 3 is a perspective view illustrating an assembled state of a moving unit and a fixed unit of FIG. 2. FIG. 4 is a perspective view illustrating an assembled state of a supporting member and a case of FIG. 2. FIG. 5 is an exploded perspective view illustrating a case and a supporting member according to another embodiment of the present invention. FIGS. 6A and 6B illustrate a focal length adjustment apparatus having the case and the supporting member of FIG. 5, FIG. 6A being a general perspective view, and FIG. 6B being a perspective sectional view taken along the line A-A of FIG. 6A.

The present invention relates to a focal length adjustment apparatus in which a magnetic fluid is injected between a magnet and a coil to achieve an improvement in a magnetic flux density and damping effect, whereby the strength of an electromagnetic force produced between the magnet and the coil can be increased and an impact-resistance, a reliability in the adjustment of a focal length, and a responsiveness can be improved.

As shown in FIG. 2, the focal length adjustment apparatus according to an embodiment of the present invention includes a moving unit 10, a fixed unit 30, a supporting member 50, and attenuation means 70. The moving unit 10 will be explained first.

The moving unit 10 is a linearly movable element of the focal length adjustment apparatus, and includes a lens barrel 12 and a coil 14. The lens barrel 12 contains at least one lens (not shown) therein. Although the lens barrel 12 may be formed into various shapes, preferably, the lens barrel 12 has a cylindrical shape. Also, it should be understood that a single lens or a plurality of lenses (not shown) may be arranged in the lens barrel 12 in consideration of desired functions and performances of a camera.

The lens barrel 12, which contains at least one lens (not shown) therein as stated above, is formed with a pair of guide slots 12a, and the coil 14 is wound throughout the outer circumference of the lens barrel 12. Although not shown in the accompanying drawings, the coil 14 is electrically connected to a power source to receive electric current therefrom.

Explaining the fixed unit 30, it includes a yoke 32 and a magnet 34. The yoke 32 is centrally formed with a through-opening to receive the above-described lens barrel 12. In FIG. 2, the fixed unit 30 has a hollow cylindrical shape, but it may have other various shapes.

The magnet 34 is affixed throughout an inner circumference of the yoke 32 having the above-described configuration to have an annular or other similar shape. To support the magnet 34, the yoke 32 has an annular base portion 32a, which protrudes inward from a lower end of the yoke 32 toward the center of the opening of the yoke 32.

The protruding base portion 32a is sized so that it protrudes inward toward the center of the yoke 32 beyond the magnet 34. The yoke 32 further has a pair of guide protrusions 32b, which protrudes upward from opposite locations of an inner edge of the protruding base portion 32a. The guide protrusions 32b are configured so that they are inserted into the guide slots 12a of the lens barrel 12. The guide protrusions 32b are spaced apart from an inner circumference of the magnet 34.

Specifically, as shown in FIG. 3, the guide protrusions 32b having the above-described configuration are inserted into the guide slots 12a formed at the lens barrel 12 when the lens barrel 12 is assembled into the center opening of the yoke 32. When being assembled in the yoke 32, the lens barrel 12 is supported at a lower surface thereof by the protruding base portion 32a of the yoke 32.

As stated above, when the yoke 32 is coupled with the lens barrel 12, the guide protrusions 32b of the yoke 32 are inserted into the guide slots 12a of the lens barrel 12, respectively. This enables easy coupling between the moving unit 10 and the fixed unit 30, achieving a predetermined positional relationship therebetween.

Referring again to FIG. 2, the yoke 32 is inserted into a hollow cylindrical case 36 after being coupled with the lens barrel 12, so that the case 36 encloses the yoke 32. That is, an assembly of the yoke 32 and the lens barrel 12 is received in the case 36. The hollow cylindrical case 36 has open upper and lower ends, but the upper end of the case 36 partially protrudes inward to form an annular top surface portion. A plurality of coupling recesses 36a is formed at the annular top surface portion of the case 36 for the seating of the supporting member 50 that will be explained hereinafter. Also, a female screw portion 36b is formed at an inner circumference of the case 36 along the lower end thereof.

An imaging sensor 36 is arranged in a lower region of the case 36 beneath the assembly of the moving unit 10 and the fixed unit 20 mounted within the case 36. The imaging sensor 90 is affixed to a sensor bracket 92, which is screwed to the female screw portion 36b of the case 36, so that a distance between the lens of the lens barrel 12 and the imaging sensor 90 is adjustable.

The supporting member 50 is seated in the coupling grooves 36a formed at the annular top surface portion of the case 36 and is used to elastically support the moving unit 10 relative to the case 36. As shown in FIG. 2, the supporting member 50 consists of a plurality of fixing extensions 52 to be seated in the coupling recesses 36a formed at the top surface portion of the case 36, and a center supporting ring 54 to be fixed to the top of the lens barrel 12. Preferably, the supporting member 50 may take the form of a plate spring.

With the above-described configuration, the lens barrel 12 is supported by the supporting member 50 so that the lower surface thereof is spaced apart from the protruding base portion 32a of the yoke 32. Thereby, the lens barrel 12 is vertically movable upon receiving an external force.

In addition to elastically supporting the lens barrel 12, the supporting member 50 serves as a damper to attenuate vibration caused upon the movement of the lens barrel 12 and to absorb external shock applied to the lens barrel 12.

Now, the attenuation means 70 will be explained.

As shown in FIG. 3, the attenuation means 70 is interposed between the magnet 34 and the coil 14, which are arranged adjacent to each other. The attenuation means 70 serves as a damper to attenuate vibration caused upon the movement of the lens barrel 12 and to relieve an external shock to be applied to the lens barrel 12.

A fluid having a viscosity, i.e. a viscous fluid may be used as the attenuation means 70. The viscous fluid is injected between the magnet 34 and the coil 14, and has a sufficient viscosity and surface tension so as not to be discharged from between the magnet 32 and the coil 14.

More preferably, a magnetic fluid having a viscosity and magnetic force may be used as the attenuation means 70. In addition to serving as a damper, the magnetic fluid injected between the magnet 34 and the coil 14 serves to increase a magnetic flux density based on a magnetism thereof when electric current is applied to the coil 14. This has the effect of increasing a transfer force of the moving unit 10.

To obtain the above-described magnetic fluid, magnetic particles are dispersed in a liquid to obtain a magnetic colloid, and a surfactant is added to the magnetic colloid to eliminate a risk of deposition or agglutination thereof. Here, viscosity and magnetization are important factors to determine the properties of the magnetic fluid. That is, damping efficiency of the magnetic fluid is determined in accordance with the viscosity. To achieve an effective damping effect, the viscosity of the magnet fluid is preferably in a range of 100 to 3000 mPa·s.

Referring to FIG. 4, each of the fixing extensions 52 of the supporting member 50, which are coupled to the top surface portion of the case 36, is provided with a damper (designated as dots). The damper is made of a vibration absorbing material, and is used to increase the attenuation efficiency of the supporting member 50.

Referring to FIG. 5 illustrating another embodiment of the present invention, a top surface portion of a case 36′ for use in the seating of the supporting member 50 has an increased cross sectional area sufficient to allow a damping fluid, i.e. fluid having a high viscosity, to fill the top surface portion of the case 36′.

As shown in FIGS. 6A and 6B, in the present embodiment, a cover 38 is affixed to the upper end of the case 36′ to cover an upper surface of the supporting member 50 after the supporting member 50 is seated on the top surface portion of the case 36′. Thereby, the supporting member 50 is concealed.

The damping fluid, i.e. viscous fluid, is injected into a space defined between the top surface portion of the case 36′ and the cover 38, i.e. into coupling recesses 36a′ formed at the top surface portion, so that the supporting member 50 is surrounded by the damping fluid. Accordingly, such a damping fluid is able to improve the attenuation efficiency of the supporting member 50.

Hereinafter, the operational effects of the focal length adjustment apparatus, with improved vibration and impact-resistance properties, according to the present invention having the above-described configuration will be explained with reference to FIG. 6B.

If electric current from an external source is applied to the coil 14 that is wound throughout the outer circumference of the lens barrel 12, an electromagnetic force is produced between the coil 14 and the magnet 34. Thereby, the lens barrel 12 is linearly moved upward and downward relative to the yoke 32 upon receiving the electromagnetic force. Such a movement of the lens barrel 12 allows a distance between the lens (not shown) received in the lens barrel 12 and the imaging sensor 90 mounted in the lower region of the case 36′ to vary, enabling the adjustment of a focal length.

Also, the focal length adjustment apparatus according to the present invention having the above-described configuration is able to attenuate an external shock applied thereto since the attenuation means 70, such as the viscous fluid or magnetic fluid, is injected between the coil 14 and the magnet 34.

The attenuation means 70 serves to prevent the lens barrel 12 from colliding with the yoke 32 or the magnet 34 even when an external shock is applied thereto. This effectively reduces a peak value in vibration at a resonance point, thereby eliminating a risk of collision between the lens barrel 12 and the yoke 32 and other constituent elements. As a result, it is possible to improve an impact-resistance property of the focal length adjustment apparatus according to the present invention.

In particular, when the attenuation means 70 is the magnetic fluid, the magnetic fluid is injected between the magnet 34 and the coil 14, thereby serving as a damper as stated above and also serving to increase a magnetic flux density based on a magnetism of the magnet 34. Thus, if electric current is applied to the coil 14, an increased amount of electromagnetic force can be produced between the coil 14 and the magnet 34.

As stated above, since the lens barrel 12 is adapted to linearly move by use of the electromagnetic force produced between the coil 14 and the magnet 34, the distance between the lens received in the lens barrel 12 and the imaging sensor 90 is variable to adjust a focal length. Such an adjustment of the focal length has the effect of reducing a response time of the lens barrel 12.

When the lens barrel 12 is stopped at a predetermined position after being transferred upon receiving the electromagnetic force, the attenuation means 70 acts to attenuate vibration generated in the lens barrel 12. This allows the lens barrel 12 to be more rapidly stopped at a desired position.

In particular, when the magnetic fluid is used as the attenuation means 70, the attenuation means 70 serves as a damper between the magnet 34 and the coil 14. Also, the attenuation means 70 serves to increase a magnetic flux density based on the strength of a magnetic field thereof, thereby achieving an increase in the transfer force of the lens barrel 12. Since the magnetic fluid is able to react on a magnetic force of the magnet 34, it can be stably filled between the magnet 34 and the coil 14 without a risk of unintentional discharge.

By virtue of the above-described vibration damping effect obtained by the attenuation means 70 injected between the coil 14 and the magnet 34, the adjustment of a focal length can be rapidly carried out via the movement of the lens barrel 12, and the responsiveness of the lens barrel 12 is improved. This enables rapid acquisition of vivid images.

The lens barrel 12 is easy to assemble with the yoke 32 by use of the corresponding guide protrusions 32b and guide slots 12a.

The use of the cover 38 affixed to the upper end of the case enables the viscous fluid (damping fluid) to be filled between the cover 38 and the upper end of the case, so that the supporting member 50 is surrounded by the fluid, resulting in an improvement in damping effect.

As is apparent from the above description, the present invention provides a focal length adjustment apparatus having the following advantages.

Firstly, according to the present invention, a magnetic fluid is injected between a magnet and a coil to achieve an improvement in a magnetic flux density and damping effect. This has the effect of increasing the strength of an electromagnetic force produced between the magnet and the coil and of improving an impact-resistance property, a reliability of focal length adjustment, and a responsiveness of the focal length adjustment apparatus.

Secondly, according to the present invention, a cover may be affixed to an upper end of a case, which receives the magnet and the coil, so that a damping fluid can be filled between the cover and the upper end of the case. This allows a supporting member, which serve as a damper, to be surrounded by the damping fluid, resulting in a further improvement in damping effect.

Thirdly, a lens barrel and a yoke, which are coupled with each other, are provided with guide slots and guide protrusions, respectively, achieving an improvement in assembling efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A focal length adjustment apparatus with improved vibration and impact-resistance properties, comprising:
a moving unit including a lens barrel that contains at least one lens therein, and a coil arranged on an outer circumference of the lens barrel;
a fixed unit including a yoke formed with an opening for receiving the lens barrel, a case into which the yoke is inserted and mounted, and a magnet affixed to the yoke to be arranged adjacent to the coil;
a supporting member used to elastically support the moving unit relative to the case; and
attenuation means interposed between the coil and the magnet to attenuate vibration of the moving unit.

2. The apparatus as set forth in claim 1, wherein the supporting member is a plate spring fixed to upper ends of both the lens barrel and the case to elastically support the lens barrel relative to the case.

3. The apparatus as set forth in claim 1, wherein a cover is coupled to the upper end of the case so that a viscous fluid is filled between the upper end of the case and the cover to surround the supporting member.

4. The apparatus as set forth in claim 1, wherein the attenuation means is a viscous fluid.

5. The apparatus as set forth in claim 1, wherein the attenuation means is a magnetic fluid having a viscosity.

6. The apparatus as set forth in claim 1, wherein an imaging sensor is mounted in a lower region of the case so that a distance between the imaging sensor and the lens is adjustable.

7. A focal length adjustment apparatus with improved vibration and impact-resistance properties, comprising:
a moving unit including a lens barrel that contains at least one lens therein and is formed with a pair of guide slots therethrough, and a coil arranged on an outer circumference of the lens barrel;
a fixed unit including a yoke that is provided with an opening for receiving the lens barrel and a pair of guide protrusions to be inserted into the guide slots, respectively, a case into which the yoke is inserted and mounted, and a magnet affixed to the yoke to be arranged adjacent to the coil;
a supporting member used to elastically support the moving unit relative to the case; and
a viscous fluid interposed between the coil and the magnet to attenuate vibration of the moving unit,
whereby the moving unit is linearly moved relative to the fixed unit upon receiving an electromagnetic force produced between the coil and the magnet, to adjust a focal length of the lens.

8. The apparatus as set forth in claim 7, wherein the supporting member is a plate spring fixed to upper ends of both the lens barrel and the case to elastically support the lens barrel relative to the case.

9. The apparatus as set forth in claim 7, wherein a cover is coupled to the upper end of the case so that a viscous fluid is filled between the upper end of the case and the cover to surround the supporting member.

10. The apparatus as set forth in claim 5, wherein the attenuation means is a magnetic fluid having a viscosity.

11. The apparatus as set forth in claim 6, wherein an imaging sensor is mounted in a lower region of the case so that a distance between the imaging sensor and the lens is adjustable.
